(19) United States
(12) Patent Application Publication
(10) Pub. No.: US 2007/0011626 A1
(43) Pub. Date: Jan. 11, 2007

(54) Apparatus and Methods for Preventing a Screen Saver or Screen Lockout Feature

(75) Inventor: Frank J. Castaneda, Raleigh, NC (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/160,778

(22) Filed: Jul. 8, 2005

(51) Int. Cl. G05D 11/00

(52) U.S. Cl. 715/867; 700/295

(57) ABSTRACT

Techniques for preventing activity monitoring software such as a screen saver or screen lockout program from interrupting other software applications running on a computer are disclosed. To this end, the apparatus includes a processor programmed to produce an output emulating activity on a time basis to preclude the activity monitoring software from taking control of the display. The apparatus also includes a connection for plugging into a port of the computer to provide the output to the computer.

The present invention generally relates to apparatus and methods for preventing the untimely operation of a screen saver or screen lock out feature.

### BACKGROUND OF THE INVENTION

Many of today's secure computer systems run secure software which requires a computer user to enter a password to continue using the computer system after a time period of inactivity. Additionally, many computer systems, in general, run screen saving software which automatically over takes the screen to display some type of moving graphics after a time period of inactivity such as the absence of user input. While secure software and screen saving software and the like, referred to collectively herein as activity monitoring software, serve a useful purpose, many times these types of software become irritating or detrimental to the computer user.

For example, a business person may be using his or her portable computer to display visual slides to aid a presentation. Many times during the presentation, a discussion may result between the business person and the audience resulting in a time period where the business person or assistant does not provide user input to the portable computer. This failure to provide input may then result in the screen saving software operating to preempt the current slide from being projected and to cause the display of some non-relevant screen saving graphic. Such preemption distracts both the business person and his or her audience from the focus of the presentation. As a presentation becomes more interactive with an audience which is the goal of most presenters, the more interruptions caused by the activity monitoring software result. Alternatively, to avoid such interruptions, the presenter may be caused to manually move a pointing device such as a mouse or to re-key in his or her user password. Neither alternative is desirable.

To address such problems, most activity monitoring software allows a user to manually set the period of inactivity before a preemption takes place. With this approach, a user would be burdened by learning the software interface of the activity monitoring software. Once learned, the user may not accurately predict the appropriate time period needed or may not remember to restore the time period after the presentation, effectively rendering the activity monitoring software perpetually useless. As noted above, another approach may involve the user or an assistant manually moving the mouse regularly during the presentation, thus requiring the presenter or the assistant to stand by the computer during the entire presentation.

Some presentation software packages programmatically disable activity monitoring software, however, many do not. Furthermore, this problem of preemption is not isolated to the presentation scenario described above. For example, a user may be reading a complex document in a document editor and, during a period of intense concentration during which no inputs are made, be interrupted by activity monitoring software.

Other typical approaches may require additional specialized hardware not typically found standard on a computer, specialized software to run on the computer running the activity monitoring software, or both.

### SUMMARY OF THE INVENTION

The present invention recognizes the need to create a cost effective hardware device which does not require additional software to execute on the computer running the activity monitoring software. Said device has minimum setup, if any. The present invention further recognizes that by emulating user input through a standard port typically found on a computer system and taking advantage of the present operation of existing software drivers, activity monitoring software can be readily managed so that it does not interrupt a user's presentation, or other computer session having relatively long periods of inactivity.

Among its several aspects, the present invention provides an apparatus, method, and computer readable medium for preventing activity monitoring software from interrupting other software applications, such as presentation software, running on a computer. To this end, the apparatus, for example, includes a processor programmed to send emulated user activity on a time controlled basis to preclude the activity monitoring software from taking control of the display, wherein the apparatus is packaged to plug into an existing port of the computer.

One advantageous aspect of the present invention includes not requiring any arbitration between software executing on the computer and the hardware plug-in device. Another advantageous aspect of the present invention includes the presence of an attached hardware plug-in device with an optional indicator to notify the user of the computer system that his or her activity monitoring software is effectively inactivated.

A more complete understanding of the present invention, as well as further features and advantages of the invention, will be apparent from the following Detailed Description and the accompanying drawings.

### BRIEF DESCRIPTION OF THE DRAWINGS

FIG. 1A illustrates a first environment in which the present invention may be advantageously employed.

FIG. 1B illustrates a second environment in which the present invention may be advantageously employed.

FIG. 2 illustrates a circuit diagram of a hardware plug-in device in accordance with the present invention suitable for use in FIG. 1A.

FIG. 3 is a flow chart illustrating the functions of software code written in accordance with the present invention and suitable for execution by the hardware plug-in of FIG. 2 or in connection with the projector of FIG. 1B.

### DETAILED DESCRIPTION

The present invention will now be described more fully with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

As will be appreciated by one of skill in the art, the present invention may be embodied as apparatus, methods, or computer program code. Accordingly, the present invention may take the form of an embodiment combining hardware and software aspects. Furthermore, the present invention may take the form of a computer program code on a computer-usable storage medium having computer-usable program code embodied in the medium. Any suitable computer readable medium may be utilized including hard disks, CD-ROMs, optical storage devices, flash memories, magnetic storage devices, and the like.

Computer program code or “code” for carrying out operations according to the present invention may be written in various programming languages such as assembly, C, C++, Java, or other languages. Software embodiments of the present invention do not depend on implementation with a particular programming language.

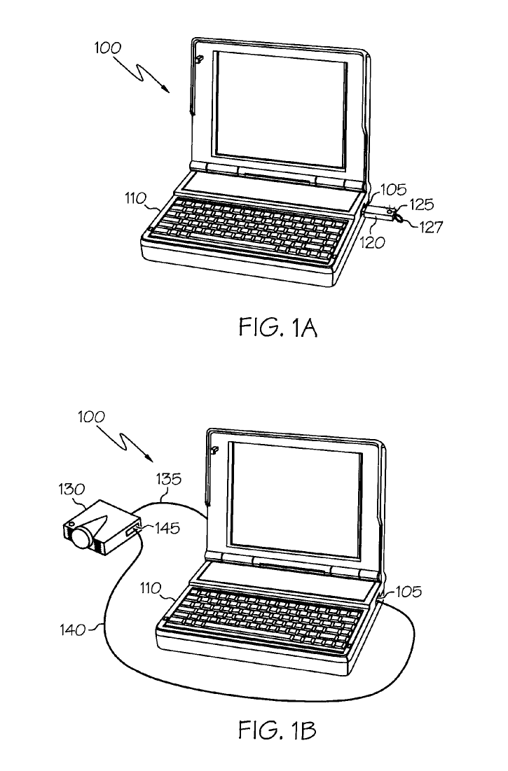

FIG. 1A illustrates a first environment 101 in which the present invention may be advantageously employed. The first environment 101 includes a portable computer 110 having a port 105 for connecting external devices. The portable computer 110 runs known activity monitoring software such as system screen savers, Webshots® screensaver, system lockouts, or the like. The first environment 101 also includes a hardware plug-in 120 according to the teachings of the present invention connected to port 105 of the portable computer 110. Port 105 is preferably a standard universal service bus (USB) port. The hardware plug-in 120 has an optional indicator 125 such as a light emitting diode to indicate that the hardware plug-in 120 is connected to portable computer 110 and, thus, activated. The hardware plug-in 120 also has an optional loop structure 127 such as a metallic ring for conveniently attaching the hardware plug-in 120 to a user's key chain, lanyard, or the like. Although the shape of the hardware plug-in 120 is depicted as rectangular, other shapes including any ergonomically suitable shapes are contemplated by the present invention.

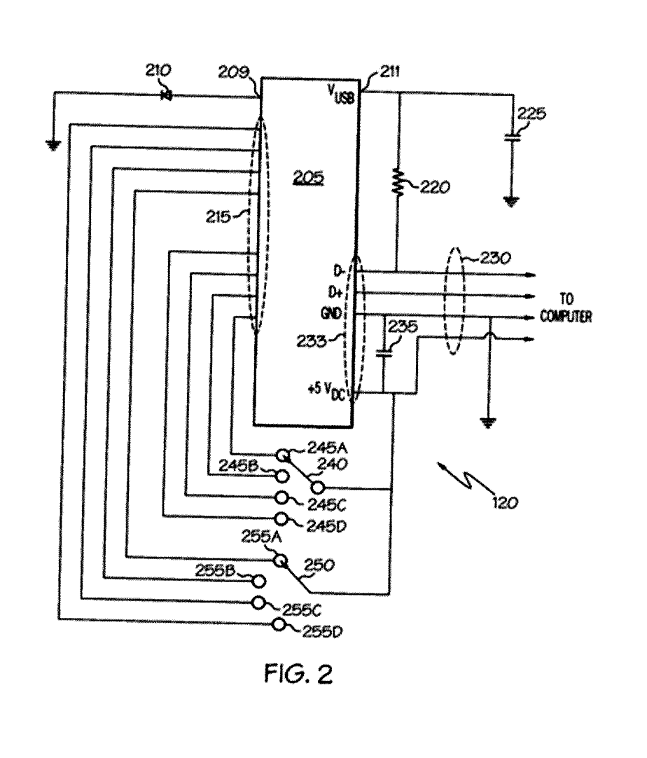

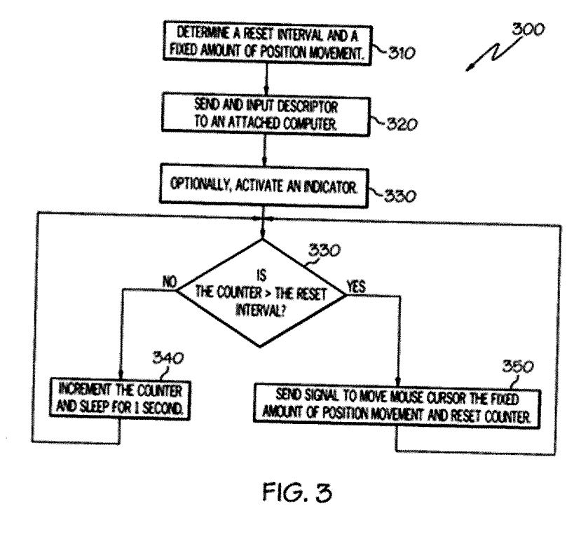

The hardware plug-in 120 emulates user activity and transmits the emulated user activity through port 105 to effectively convince activity monitoring software that a user is providing input to portable computer 110 and should not be interrupted. The contents of hardware plug-in 120 will be discussed in further detail in connection with the discussion of FIG. 2. The code, according to the teachings of the present invention and running in the hardware plug-in 120, will be discussed in further detail in connection of FIG. 3.

It should be noted that although the portable computer 110 is depicted as a laptop computer, the present invention applies to any computer system including a server, a workstation, a desktop, and the like which have a standard port, such as port 105.

FIG. 1B illustrates a second environment 102 in which the present invention may be advantageously employed. The second environment 102 includes a projector 130 and the portable computer 110. The projector 130 has a port 145 compatible with port 105 such as a USB port. The projector 130 connects to the video output of the portable computer 110 with video cable 135. Additionally, the projector 130 connects to port 105 of the portable computer 110 with a cable 140. In this environment, software code, in accordance with the teachings of the present invention, which is described in further detail in connection with FIG. 3 executes on a central processing unit in projector 130. In this second environment 102, the central processing unit in projector 130 emulates user activity and transmits the emulated user activity through port 105 to convince activity monitoring software that a user is providing input to portable computer 110.

FIG. 2 illustrates a circuit diagram of the hardware plug-in 120 of FIG. 1A in accordance with the present invention. The hardware plug-in 120 includes a central processing unit (CPU) 205, a optional light emitted diode (LED) 210, a resistor 220, capacitors 225 and 235, and optional switches 240 and 250. The central processing unit 205 is preferably a low cost microcontroller such as Microchip's PIC 16C745/765 microcontroller.

The CPU has data inputs 215, optional power output port 209, output power port 211, and USB interface ports 233. The USB interface ports 233 include a negative data port (D−), a positive data port (D+), ground (GND), and a +5V voltage source (V_{DC}). The CPU turns on power output port 209 and, thus, the light emitted diode 211 becomes lit when the hardware plug-in 120 connects into a computer port.

Resistor 220 connects output power port 211 with the negative data port D− and connects to capacitor 225. Preferably, resistor 220 is a 1.50 resistor and capacitor 225 is a 200 nanofarads (nF) capacitor. Optional power output port 209 connects to diode 210. The GND and V_{DC} ports of USB interface ports 233 are connected with capacitor 235. Preferably, capacitor 235 is a 0.1 μF capacitor. V_{DC} port of USB interface ports 233 also connects to optional switches 240 and 250. When the hardware plug-in 120 is connected with a computer such as portable computer 110 which is running activity monitoring software, the USB interface ports 233 also connect to the USB interface of the computer.

Optional switch 240 connects to one of four data input ports over paths 245A-245D. Optional switch 250 connects to one of four data input ports over paths 255A-255D. Optional switches 240 and 250 may suitably be manufactured as conventional dual in-line package (DIP) switches. The CPU and other illustrated devices and paths may be manufactured on a printed circuit board, a single silicon or ceramic chip, or any other substrate utilizing known techniques.

Switch 240 controls the amount of relative position displacement of an input device, such as a pointer device, on the connected computer. For example, when switch 240 connects to a data input of CPU 205 over path 245A, the CPU 205 will sense that the path 245A is not an open circuit. Thus, the software code, described in further detail in FIG. 3, instructs CPU 205 to send a position displacement of +1 unit at the expiration of a specified interval out the D+ port to an attached computer. The specified interval is determined relative to the setting of optional switch 250 described below. Similarly, when switch 240 connects to a data input of CPU 205 over paths 245B, 245C, and 245D, the CPU 205 will send, for example, a position displacement of +5, +10, or +15 units, respectively, at the expiration of the specified interval out the D+ port to an attached computer. To prevent a user of the computer connecting with the hardware plug-in 120 from visibly noticing a cursor movement, each positive position displacement is subsequently followed by a corresponding negative position displacement of the same amount. It should be noted that the range of position displacements is between 0 and 128 units. More specifically, in a USB interface, the specific position displacements are specified in three bytes of data. The three bytes of data which describe the relative position displacement utilizes X and Y coordinates. It should also be noted that from the attached computer's perspective, the hardware plug-in is viewed as a second input device which controls the actual pointing cursor being displayed. Consequently, as with USB devices, in general, different attached devices may command the same resources on the computer. The operating system software of the computer executes the commands from multiple devices without excluding each other. Thus, arbitration between multiple devices commanding the same resource is not necessary. For example, the pre-existing mouse driver which runs on the attached computer will, thus, interpret the relative position displacements received from the hardware plug-in 120 as if the position displacements resulted from the user moving that mouse device.

Switch 250 controls the specified interval of time which passes before a relative position displacement as described above is sent. For example, when switch 250 connects to a data input of CPU 205 over path 255A, the CPU 205 will sense that the path 255A is not an open circuit. Thus, the software code, described in further detail in FIG. 3, instructs CPU 205 to set a timer which pops every 5 minutes at which point a relative position displacement is sent as described above. Similarly, when switch 250 connects to a data input of CPU 205 over paths 255B, 255C, and 255D, the CPU 205 will set a timer which pops, for example, every 10, 15, or 20 minutes, respectively.

Switches 240 and 250 are optional because the software code, according to the teachings of the present invention, may establish by default the amount of relative position displacement of an input device and a specified interval of time which passes before the relative position displacement is transmitted to the computer. In any combination of settings for switches 240 and 250 or defaulted values, for that matter, the resulting movement of the cursor or pointing device on the attached computer's display is not perceptually significant either because the movement of the cursor is small or the time between adding and subtracting the same position displacement is fast.

FIG. 3 is a flow chart 300 illustrating the functions of software code written in accordance with the present invention and executed by the hardware plug-in of FIGS. 1A and 2, or the projector of FIG. 1B. At step 310, a reset interval and a fixed amount of position displacement to communicate to an attached computer system is determined. In the first environment 101, CPU 205 may sense which data inputs of data input ports 215 have a closed circuit connection. In the second environment 102, the CPU disposed in projector 130 may be configured through the projector's interface, for example. At step 320, an input descriptor, such as a USB mouse descriptor, is sent to the attached computer. The input descriptor associates, for example, the hardware plug-in 120 or projector 130 with a USB mouse so that subsequent communication with the attached computer will specify the input descriptor along with a request to move the current pointer position. At step 330, an indicator is optionally activated. The indicator, if applicable, is preferably an LED, such as LED 210, to indicate to the user of the attached computer that the activity monitoring software is effectively deactivated while the LED is lit. At step 330, the flow chart 300 tests whether a counter is greater than the reset interval. In other words, the flow chart 300 tests whether the reset interval timer popped. If yes, the flow chart 300 proceeds to step 350. At step 350, a signal to emulate an input device such as to move a mouse cursor the fixed amount of position displacement is sent. Furthermore, at step 350 the counter or timer is reset. Step 350 then proceeds to step 330.

Returning to step 330, if the counter's value is less than the reset interval, the flow chart 300 proceeds to step 340. At step 340, the counter is incremented and the software code sleeps for one second to avoid needless tests of step 330. The flow chart 300 then proceeds to step 330 to again test the counter against the reset interval.

While the present invention has been disclosed in the context of various aspects of presently preferred embodiments, it will be recognized that the invention may be suitably embodied consistent with the claims which follow. Such embodiments include randomizing the specified time interval or randomizing the amount of relative position displacements.

What is claimed is:

1. An apparatus for coupling to a computer running activity monitoring software which controls the computer's display after a period of inactivity, the apparatus comprising:
a processor programmed to produce an output emulating user activity on a time basis to preclude the activity monitoring software from taking control of the display; and
a connection plug for plugging into a port of the computer to provide said output to the computer.

2. The apparatus of claim 1 wherein the emulated user activity comprises cursor position displacement.

3. The apparatus of claim 1 wherein the connection plug is a USB connection.

4. The apparatus of claim 1 wherein the time basis for emulating user activity comprises a time interval, the end of which the processor sends emulated user activity, said time interval is smaller than the period of inactivity.

5. The apparatus of claim 1 wherein the emulated user activity comprises a positive position displacement followed by a negative position displacement of the same amount so as to not be visually apparent.

6. The apparatus of claim 1 further comprising:
an indicator to indicate that the activity monitoring software is effectively disabled.

7. The apparatus of claim 1 further comprising:
a loop structure for removeably attaching the apparatus.

8. The apparatus of claim 4 further comprising:
a switch connected to the processor for selecting a value for the time interval.

9. A method for preventing activity monitoring software from interrupting a displayed image on a computer after a period of inactivity, the method comprising:
connecting a pluggable device into the computer; and
sending emulated user activity on a time basis to preclude the activity monitoring software from taking control of the display.

10. The method of claim 9 wherein the emulated user activity comprises a cursor position displacement.

11. The method of claim 9 wherein the pluggable device is a projector.

12. The method of claim 9 wherein the pluggable device has a USB connection.

13. The method of claim 9 wherein the sending emulated user activity step further comprises:
determining a time interval, the end of which emulated user activity is sent, said time interval is smaller than the period of inactivity.

14. The method of claim 10 wherein the sending emulated user activity step further comprises:
sending a positive cursor position displacement followed by a negative cursor position displacement of the same amount so as to not be visually apparent.

15. A computer readable medium whose contents cause a processor which plugs in a computer system to prevent an interruption of the computer system's screen after a period of inactivity caused by activity monitoring software executing on the computer system, by performing the steps of:
determining a time basis; and
sending emulated user activity on the time basis to the computer system to preclude the activity monitoring software from taking control of the display.

16. The computer readable medium of claim 15 wherein the emulated user activity comprises a cursor position displacement.

17. The computer readable medium of claim 15 wherein the computer readable medium is disposed in a projector.

18. The computer readable medium of claim 15 wherein the processor has a USB connection.

19. The computer readable medium of claim 15 wherein the determining time basis step further comprises:
determining a time interval, the end of which emulated user activity is sent, said time interval is smaller than the period of inactivity.

20. The method of claim 16 wherein the sending emulated user activity step further comprises:
sending a positive cursor position displacement followed by a negative cursor position displacement of the same amount so as to not be visually apparent.
